(19) United States
(12) Patent Application Publication
(10) Pub. No.: US 2010/0011230 A1
(43) Pub. Date: Jan. 14, 2010

(54) LINK AGGREGATION WITH DYNAMIC BANDWIDTH MANAGEMENT TO REDUCE POWER CONSUMPTION

(76) Inventor: Olaf Mater, Eggenstein-Leopoldshafen (DE)

Correspondence Address: SCHWABE, WILLIAMSON & WYATT, P.C., PACWEST CENTER, SUITE 1900, 1211 S.W. FIFTH AVENUE, PORTLAND, OR, 97204, US

(21) Appl. No.: 12/490,997

(22) Filed: Jun. 24, 2009

Related U.S. Application Data
(60) Provisional application No. 61/078,967, filed on Jul. 8, 2008.

(51) Int. Cl. G06F 1/32

(52) U.S. Cl. 713/320

(57) ABSTRACT

Embodiments of the present invention provide configurations and techniques for determining, by link aggregation logic, whether a load of network traffic communicated across a team of aggregated links allows inactivation of one or more aggregated links of the team, wherein the team of aggregated links is coupled with a plurality of network interface cards (NICs). On determining that the load of network traffic communicated across the team of aggregated links allows inactivation of the one or more aggregated links of the team, the link aggregation logic is configured to power off or place into a power save mode one or more NICs of the plurality of NICs corresponding to the one or more aggregated links. Other embodiments may be described and/or claimed.

### CROSS REFERENCE TO RELATED APPLICATIONS

The present application claims priority to U.S. Patent Application No. 61/078,967, filed Jul. 8, 2008, entitled “Link Aggregation with Dynamic Bandwidth Management to Reduce Power Consumption,” the entire specification of which is hereby incorporated by reference in its entirety for all purposes, except for those sections, if any, that are inconsistent with this specification.

### TECHNICAL FIELD

Embodiments of the present invention relate to the field of computer networks, and more particularly, to link aggregation techniques of computer networks.

### BACKGROUND

Generally, link aggregation is an emerging technology to provide increased speed or increased redundancy for higher availability in a computer network. For example, network interface cards may be trunked together to form network links that exceed the speed of any single network card. Such network interface cards may consume a significant amount of power. Network traffic may vary considerably over time such that the full bandwidth of all aggregated links is not utilized at all times.

### SUMMARY

In various embodiments, the present disclosure provides a method comprising determining, by link aggregation logic, whether a load of network traffic communicated across a team of aggregated links allows inactivation of one or more aggregated links of the team, wherein the team of aggregated links is coupled with a plurality of network interface cards (NICs), and on determining that the load of network traffic communicated across the team of aggregated links allows inactivation of the one or more aggregated links of the team, powering off or placing into a power save mode one or more NICs of the plurality of NICs corresponding to the one or more aggregated links.

In various embodiments, the present disclosure provides an apparatus comprising a plurality of network interface cards (NICs), a plurality of physical links coupling the plurality of NICs with a switch, wherein the plurality of physical links are aggregated to form a team of aggregated links, and link aggregation logic configured to determine whether a load of network traffic communicated across the team allows inactivation of one or more aggregated links of the team, and to power off or place into a power save mode one or more NICs of the plurality of NICs corresponding to the one or more aggregated links on determining that the load of network traffic allows inactivation of the one or more aggregated links.

### BRIEF DESCRIPTION OF THE DRAWINGS

Embodiments of the present invention will be readily understood by the following detailed description in conjunction with the accompanying drawings. To facilitate this description, like reference numerals designate like structural elements. Embodiments of the invention are illustrated by way of example and not by way of limitation in the figures of the accompanying drawings.

FIG. 1 is a schematic diagram of a link aggregation system, in accordance with various embodiments of the present invention;

FIG. 2 is a process flow diagram of a method, in accordance with various embodiments of the present invention.

### DETAILED DESCRIPTION OF EMBODIMENTS OF THE INVENTION

Embodiments of the present invention may describe link aggregation with dynamic bandwidth management to reduce power consumption and associated techniques and configurations. In the following detailed description, reference is made to the accompanying drawings which form a part hereof wherein like numerals designate like parts throughout, and in which is shown by way of illustration embodiments in which the invention may be practiced. It is to be understood that other embodiments may be utilized and structural or logical changes may be made without departing from the scope of the present invention. Therefore, the following detailed description is not to be taken in a limiting sense, and the scope of embodiments in accordance with the present invention is defined by the appended claims and their equivalents.

The description may use perspective-based descriptions such as up/down, back/front, and top/bottom. Such descriptions are merely used to facilitate the discussion and are not intended to restrict the application of embodiments of the present invention.

For the purposes of the present invention, the phrase “A/B” means A or B. For the purposes of the present invention, the phrase “A and/or B” means “(A), (B), or (A and B).” For the purposes of the present invention, the phrase “at least one of A, B, and C” means “(A), (B), (C), (A and B), (A and C), (B and C), or (A, B and C).”

The description may use the phrases “in an embodiment,” or “in embodiments,” which may each refer to one or more of the same or different embodiments. Furthermore, the terms “comprising,” “including,” “having,” and the like, as used with respect to embodiments of the present invention, are synonymous.

The terms “predictor,” “optimizer,” “analyzer,” or “system level manager” may refer to respective hardware and/or software implementing entities, and do not include a human being. For example, the operations performed by the “predictor”, “optimizer,” “analyzer,” or “system level manager” are operations performed by the respective hardware and/or software implementations, e.g. operations that transform data representative of real things from one state to another state. Such operations do not include mental operations performed by a human being.

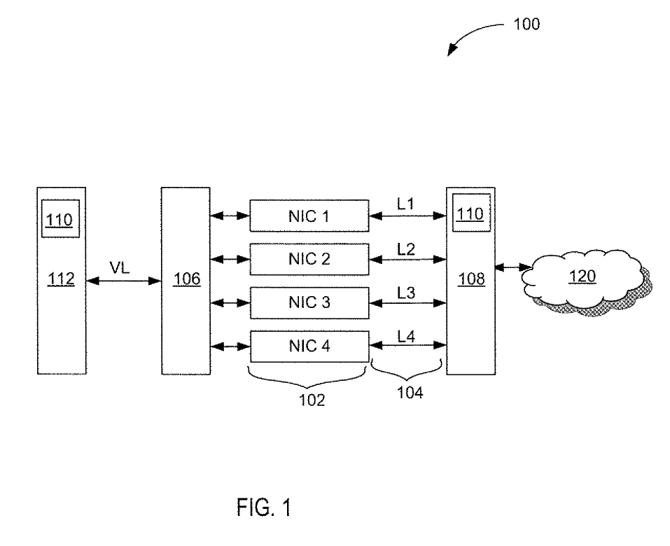

FIG. 1 is a schematic diagram of a link aggregation system 100, in accordance with various embodiments of the present invention. In an embodiment, link aggregation system 100 includes a plurality of network interface cards (NICs) 102, a plurality of physical links 104, a team of aggregated links represented by a virtual network interface card 106, a switch 108, link aggregation logic 110, a computing device 112, and a network 120, coupled as shown.

In the embodiment depicted in FIG. 1, four network interface cards (NIC 1, NIC 2, NIC 3, and NIC 4) are each coupled with a respective physical link (L1, L2, L3, and L4). The physical links 104, in turn, are coupled with the switch 108. FIG. 1 is merely one representation of a link aggregation system 100, and in other embodiments, more or less NICs 102 and/or physical links 104 may be used.

The plurality of NICs 102 may include different types of NIC that allow computing devices to communicate over a network, including, for example, NICs that support Ethernet, Token Ring, or other protocols, whether by cable or wirelessly, or other techniques. The plurality of NICs 102 may consume a considerable amount of power when active. For example, an active NIC 102 coupled with a physical link 104 having a bandwidth of about 1 gigabyte (GB)/second (s) may consume about 2 watts (W) of power. Subject matter is not limited in this regard and the plurality of NICs 102 may consume more or less power in other embodiments.

In an embodiment, the plurality of physical links 104 are aggregated to form the team of aggregated links 106. Link aggregation may be referred to as “NIC teaming”, “port channeling”, or “Ethernet trunking”, or other analogous terms or variants, in one or more embodiments. The plurality of physical links 104 may be aggregated, trunked, or combined to form a single logical link or team 106 by any of a variety of well-known link aggregation techniques. For example, in the embodiment depicted in FIG. 1, physical links L1, L2, L3, and L4 may be aggregated to form the team of aggregated links 106 by link aggregation logic 110.

Link aggregation logic 110 may be operatively coupled with the plurality of NICs 102 to perform a variety of functions including aggregating one or more physical links 104 to form the team of aggregated links 106. Link aggregation logic 110 may be stored on the computing device 112 or the switch 108, or other storage device, in one or more embodiments and may be implemented using software or firmware, for example, at the device driver layer. Link aggregation may be implemented at other levels in other embodiments. The link aggregation logic 110 may be executed by a processor of the computing device 112, or the switch 108, or another processor.

The team of aggregated links 106 may form or provide a virtual network interface card (NIC) that uses a single virtual or logical link (VL) to communicate with the computing device 112. In an embodiment, link aggregation logic 110 or the team of aggregated links 106 comports with Institute of Electrical and Electronics Engineers (IEEE) standards such as IEEE 802.1AX and/or IEEE 802.3 standards, including, for example, Link Aggregation Control Protocol (LACP). Link aggregation logic 110 or the team of aggregated links 106 may be consistent with other standards or protocols in other embodiments.

The link aggregation system 100 that includes the team of aggregated links 106 may provide a more reliable network connection by, for example, providing redundancy for higher availability. The team of aggregated links 106 may also provide a higher bandwidth network connection than any of the single physical links 104 alone.

The computing device 112 may be coupled with the team of aggregated links 106 by the virtual link, VL. Computing device 112 may represent a host of computing devices, including, for example, servers, desktop computer systems, laptop computer systems, personal computers (PC), wireless telephones, personal digital assistants (PDA) including cellular-enabled PDAs, set top boxes, pocket PCs, or tablet PCs, but is not limited to these examples and may include other computing devices in other embodiments. Computing device 112 may communicate with the network 120 via the team of aggregated links 106 and the switch 108.

The switch 108 is intended to represent a broad variety of devices that couple multiple computing devices together within the network 120, including, for example, hubs or routers. In an embodiment, the switch 108 is configured to inspect data packets received from the network 120, determine source and destination of the data packets, and transfer the data packets to the destination. The switch 108 may be configured to couple the computing device 112 with the network 120, such as a local area network (LAN), or a wide area network (WAN), according to various embodiments. Subject matter is not limited in this regard and the switch 108 may be configured to couple the computing device 112 with other types of networks in other embodiments.

Link aggregation logic 110 may be configured to perform a variety of operations. In an embodiment, the link aggregation logic 110 is configured to distribute outgoing or transmitted network traffic across active or available physical links 104, or to distribute incoming or received network traffic across active or available physical links 104 and merge the network traffic to the single virtual link, VL, in a manner that optimizes network speed of the link aggregation system 100. In an embodiment, the link aggregation logic 110 is configured to provide dynamic bandwidth management to account for fluctuating loads of network traffic. For example, the link aggregation logic 110 may be configured to dynamically inactivate or activate one or more physical links 104 based on bandwidth needs to support a load of network traffic.

An “inactivated” link as described herein may broadly refer to either an inactivated physical link 104 or a logical link of the team of aggregated links 106 representative of the physical link 104. Inactivated links may be referred to as “inactive” links and activated links may be referred to as “active” links. In other embodiments, inactivated links may be referred to as “disabled” links and activated links may be referred to as “enabled” links. The link aggregation logic 110 may comprise an analyzer, or an optimizer, or a predictor, or a system level manager to perform such functions.

In an embodiment, the link aggregation logic 110 is configured to measure a load of network traffic communicated, i.e., transmitted or received, or combinations thereof, across the team of aggregated links 106. The link aggregation logic 110 may be further configured to determine a bandwidth of active links of the team of aggregated links 106 and to compare the load of network traffic with the bandwidth of the active links of the team 106.

Link aggregation logic 110 may be configured to determine whether a load of network traffic communicated across the team 106 allows inactivation of one or more aggregated links of the team 106. Such determination may be performed on a continuous or dynamic basis. Alternatively, such determination may also be performed on an intermittent basis.

In an embodiment, the load of network traffic may allow inactivation of one or more aggregated links of the team 106 if the total potential bandwidth of all active links of the team 106 is sufficiently greater than the actual bandwidth used by the load of network traffic. The total potential bandwidth of all active links of the team 106 may be sufficiently greater, for example, if one or more aggregated links of the team 106 are not needed to support the load of network traffic. In an embodiment, the link aggregation logic 110 is configured to determine whether a bandwidth of the team 106 without one or more of its aggregated links is sufficient to support the load of network traffic communicated across the team 106.

Link aggregation logic 110 may be configured to power off or place into a power save mode one or more of the plurality of NICs 102 coupled to the one or more aggregated links of the team 106 on determining that the load of network traffic allows inactivation of the one or more aggregated links. Link aggregation logic 110 may be further configured to power off or place into a power save mode the one or more NICs coupled to the one or more inactive aggregated links of team 106.

Link aggregation system 100 may also be equipped to activate one or more aggregated links of the team 106 to support a growing load of network traffic. In an embodiment, the link aggregation logic 110 is configured to determine whether one or more inactive links, if any, of the team 106 are needed to provide more bandwidth for a load of network traffic and then activate the one or more inactive links accordingly. Link aggregation logic 110 may be further configured to power on or restore a normal power mode to one or more of the plurality of NICs 102 coupled to the one or more activated links of the team 106, thereby meeting a rising demand of network traffic.

Embodiments described herein may significantly reduce power consumption. For example, if links L1, L2, L3, and L4 each have a bandwidth of about 1 GB/s, then aggregated virtual link, VL, of team 106 has a bandwidth of about 4 GB/s when all links are active. Subject matter is not limited in this regard and other bandwidths or more or less links 104 or NICs 102 may be used in other embodiments. If, for example, links L2, L3, and L4 are inactivated, and link L1 remains active, then aggregated virtual link, VL, of team 106 has a bandwidth of about 1 GB/s. In such example, NIC 1 remains powered on and running in normal power mode and NIC 2, NIC 3, and NIC 4 are powered down or running in power save mode. A link aggregation configuration 300 that places one or more NICs 102 into a power save mode as described in this example may reduce power consumption by greater than about 50%.

Links L1, L2, L3, and L4 may be inactivated by techniques described herein and respective network interface cards NIC 1, NIC 2, NIC 3, and NIC 4 may be powered down or placed in a power save mode according to techniques described herein. In an embodiment, Links L1, L2, L3, and L4 and network interface cards NIC 1, NIC 2, NIC 3, and NIC 4 may be activated and restored to normal power mode according to techniques described herein.

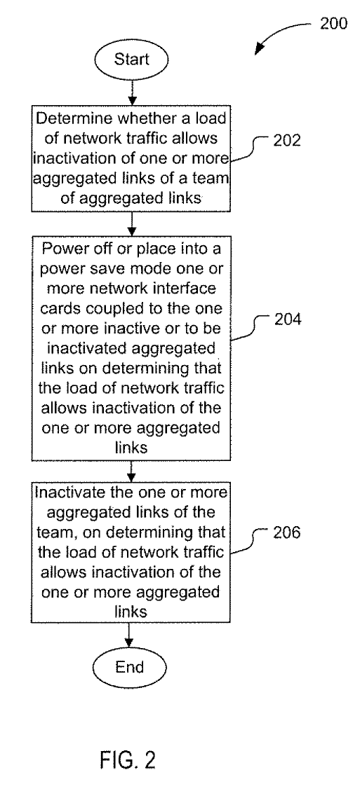

FIG. 2 is a process flow diagram of a method, in accordance with various embodiments of the present invention. In an embodiment, method 200 includes determining whether a load of network traffic allows inactivation of one or more aggregated links of a team of aggregated links at block 202. Method 200 may further include powering off or placing into a power save mode one or more network interface cards coupled to the one or more inactive or to be inactivated aggregated links on determining that the load of network traffic allows inactivation of the one or more aggregated links at block 204. At block 206, method 200 may further include inactivating the one or more aggregated links of the team, on determining that the load of network traffic allows inactivation of the one or more aggregated links.

Determining whether a load of network traffic allows inactivation of one or more aggregated links at block 202 may include measuring the load of network traffic, determining a bandwidth of active links of the team of aggregated links, and comparing the network load and the bandwidth of the active links. Determining whether a load of network traffic allows inactivation of one or more aggregated links, at block 202, may include determining whether a bandwidth of the team of aggregated links without the one or more aggregated links is sufficient to support the load of network traffic communicated, i.e., transmitted or received, or combinations thereof, across the team of aggregated links. Such determining may be continuous or dynamic, including intermittent.

Method 200 may further include powering off or placing into a power save mode one or more NICs of the plurality of NICs coupled to the one or more aggregated links at block 204. Powering off or placing into the power save mode may be performed in response to a determination that the load of network traffic communicated across the team of aggregated links allows inactivation of the one or more aggregated links of the team. Powering off or placing into power save mode one or more NICs may be performed before or after, or simultaneously with, inactivating the one or more aggregated links of the team, at block 206, according to various embodiments. In an embodiment, powering off or placing into power save mode one or more NICs is performed on one or more NICs coupled to one or more inactive aggregated links.

Powering off or placing into power save mode one or more NICs may be performed by link aggregation logic. In an embodiment, powering off or placing into power save mode one or more NICs reduces power consumption of the plurality of NICs, and thus, reduces power consumption of a system that incorporates the plurality of NICs. Method 200 may further include inactivating the one or more aggregated links of the team, on determining that the load of network traffic communicated allows inactivation of the one or more aggregated links of the team at block 206.

Method 200 may further include operations to activate inactive links of the team to support an increasing load of network traffic. In an embodiment, method 200 includes determining whether one or more of the inactive links of the team of aggregated links are needed to provide more bandwidth for the load of network traffic communicated across the team of aggregated links, activating the one or more inactive links on determining that the one or more inactive links are needed to provide more bandwidth for the load of network traffic, and powering on or restoring normal power mode to the one or more NICs of the plurality of NICs coupled to the one or more activated links of the team of aggregated links. NICs may be restored to normal power mode prior to activating the inactive links, or vice versa, in various embodiments. NICs may be restored to normal power mode simultaneously with activating the inactive links in one or more embodiments.

Determining whether one or more of the inactive links of the team are needed to provide more bandwidth for the load of network traffic may be performed continuously or dynamically, including intermittently. Determining whether one or more of the inactive links of the team are needed to provide more bandwidth for the load of network traffic may further include measuring the load of network traffic, determining a bandwidth of active links of the team of aggregated links, and comparing the load of network traffic with the bandwidth of the active links.

An article of manufacture is also disclosed herein. In an embodiment, an article of manufacture includes a storage medium having instructions stored thereon that, if executed, result in the actions or operations described herein with respect to FIGS. 1-2. In accordance with various embodiments, the article of manufacture may be a computer-readable medium.

Various operations may have been described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

Although certain embodiments have been illustrated and described herein for purposes of description of the preferred embodiment, it will be appreciated by those of ordinary skill in the art that a wide variety of alternate and/or equivalent embodiments or implementations calculated to achieve the same purposes may be substituted for the embodiments illustrated and described without departing from the scope of the present invention. Those with skill in the art will readily appreciate that embodiments in accordance with the present invention may be implemented in a very wide variety of ways. This application is intended to cover any adaptations or variations of the embodiments discussed herein. Therefore, it is manifestly intended that embodiments in accordance with the present invention be limited only by the claims and the equivalents thereof.

What is claimed is:

1. An apparatus comprising:
a plurality of network interface cards (NICs);
a plurality of physical links coupling the plurality of NICs and a switch, wherein the plurality of physical links are aggregated to form a team of aggregated links; and
link aggregation logic configured to
determine whether a load of network traffic communicated across the team allows inactivation of one or more aggregated links of the team; and
power off or place into a power save mode one or more of the plurality of NICs corresponding to the one or more aggregated links on determining that the load of network traffic allows inactivation of the one or more aggregated links.

2. The apparatus of claim 1, wherein the team of aggregated links forms a virtual NIC.

3. The apparatus of claim 2, further comprising:
a virtual link to couple the virtual NIC to a computing device.

4. The apparatus of claim 3, further comprising:
the computing device coupled to the virtual NIC via the virtual link.

5. The apparatus of claim 1, further comprising:
the switch coupled with the plurality of NICs via the plurality of physical links.

6. The apparatus of claim 1, wherein the switch is coupled to a network.

7. The apparatus of claim 1, wherein each physical link of the plurality of physical links is coupled with a respective NIC of the plurality of NICs.

8. The apparatus of claim 1, wherein the link aggregation logic comprises an analyzer.

9. The apparatus of claim 1, wherein the team of aggregated links comports with a standard including at least one of IEEE 802.1AX, IEEE 802.3, and combinations thereof.

10. The apparatus of claim 1, wherein the link aggregation logic is further configured to:
inactivate the one or more aggregated links of the team on determining that the load of network traffic allows inactivation of the one or more aggregated links.

11. The apparatus of claim 10, wherein the link aggregation logic is further configured to:
power off or place into the power save mode the one or more NICs corresponding to one or more inactivated aggregated links of the team.

12. The apparatus of claim 1, wherein the link aggregation logic is further configured to:
measure the load of network traffic;
determine a bandwidth of active links of the team of aggregated links; and
compare the load of network traffic with the bandwidth of the active links.

13. The apparatus of claim 1, wherein the link aggregation logic is further configured to:
determine whether a bandwidth of the team of aggregated links without the one or more aggregated links is sufficient to support the load of network traffic.

14. The apparatus of claim 1, wherein the link aggregation logic is further configured to determine whether the load of network traffic allows inactivation of one or more of the aggregated links of the team on a continuous or dynamic basis.

15. The apparatus of claim 1, wherein the link aggregation logic is further configured to:
determine whether one or more inactive links, if any, of the team of aggregated links are needed to provide more bandwidth for the load of network traffic;
activate the one or more inactive links on determining that the one or more inactive links are needed to provide more bandwidth for the load of network traffic; and
power on or restore normal power mode to the one or more of the plurality of NICs corresponding to the one or more activated links of the team of aggregated links.

16. The apparatus of claim 15, wherein the link aggregation logic is further configured to determine whether one or more inactive links, if any, of the team of aggregated links are needed to provide more bandwidth for the load of network traffic on a continuous, dynamic, or intermittent basis.
